(19) United States
(12) Patent Application Publication
(10) Pub. No.: US 2008/0128447 A1
(43) Pub. Date: Jun. 5, 2008

(54) Apparatus and Method for Stacking Containers

(76) Inventor: John Riedl, Northbridge (AU)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/851,210

(22) Filed: Sep. 6, 2007

Related U.S. Application Data
(63) Continuation of application No. PCT/AU06/00297, filed on Mar. 7, 2006.

(30) Foreign Application Priority Data
Mar. 7, 2005 (AU) AU 2005901064

(51) Int. Cl. G07F 11/12

(52) U.S. Cl. 221/11

(57) ABSTRACT

An apparatus and method are provided for the stacking of containers. The apparatus includes a plurality of substantially horizontal pairs of gates positioned in a substantially vertical series. Operatively, each gate pair can be selectively closed or opened to allow containers to either rest at each gate pair or pass through, so as to deliver a stack of containers below the gate pairs.

### CROSS REFERENCE TO RELATED APPLICATION(S)

This application is a continuation of International Application No. PCT/AU2006/000297, filed on Mar. 7, 2006, which claims priority to Australian Application No. 2005901064, filed on Mar. 7, 2005, the contents of both of which are incorporated in their entirety herein by reference.

### FIELD OF THE INVENTION

The present invention relates to manufacturing operations and in particular to a method and apparatus for the stacking of containers during a manufacturing operation.

### BACKGROUND OF THE INVENTION

In manufacturing operations, speed of the production line and enhanced productivity are the two key goals sought by manufacturers.

There are a number of manufacturing operations that produce containers that are typically used in conjunction with food for trading in locations such as supermarkets, bakeries, pie shops and other take away food shops. These containers can be made from a variety of materials, such as plastic, paper or paper composites and aluminium foil. For example, aluminium food containers or dishes are used to hold food such as pies, pasties, pasta and lasagna products. Typically, the containers used for this purpose are initially open-topped and hollow, and are usually manufactured so they can be stacked on top of and within one another prior to use.

In one common form of manufacture, the manufacture of such containers begins with the material, such as aluminium foil or paper, being fed into a stamping press which forms the shape of the container using a die. Other forming processes can be used for other materials.

The formed containers are then ejected from the press or other shaping process at a range of speeds depending upon the die or tool used to form the container, the speed of the press, and the size, weight, shape and material of the container. Typically, ejection speeds from tens of containers per minute up to several hundreds of containers per minute are experienced.

After the containers have been formed and ejected from the press or process, they need to be stacked in pre-determined quantities for packaging and shipping to the customer.

The containers may be ejected from the press by various means. For example, the containers may be ejected by mechanical means such as a piston or pushing mechanism contained within the die. Alternatively, the containers may be ejected using a blast of compressed air. In recent designs, the containers are ejected using a combination of an ejection mechanism and an air blast.

Irrespective of the method of ejection used, the containers so ejected are then often transferred to a stacking operation using a conveyor means. Such a conveyor may be powered using a moving belt or a multiplicity of belts, or unpowered comprising a chute operating under gravity.

In one form of art used for stacking, the containers are randomly caught in a net or other similar containment means situated at the end of the conveyor or chute. A human operator then physically counts and stacks the containers ready for shipment. Counting may be assisted by measuring gauges or weighing scales. While this method works with all types of container it is generally slow or expensive in labour content or both.

In another form of art used for stacking, the containment means may be a shaker table, which assists small round or square containers to nest within each other whilst being shaken. A human operator then collects the partially formed stacks and counts and assembles the required quantity of containers in each stack. Once again, measuring gauges or weighing scales may be used to assist. Overall, this provides a rudimentary semi-automatic stacking system, where the speed and productivity are still based upon the inherent limitations of a human operator.

The shaker table method of stacking is generally limited to use with small containers. Medium and large containers are prone to damage using this method and do not tend to nest correctly or sufficiently quickly in large enough stacks. These problems are exacerbated with rectangular containers, and such containers are generally not workable with this form of stacking. Thus, for larger containers and also for rectangular or other shapes of container than circular or square, other forms of semi-automatic or automatic stacking are required to economically produce containers where labour costs may otherwise be high.

One problem with further automating the stacking operation was the randomness of orientation and direction with which some containers were ejected from the press or machine. Depending on the speed of production, the shape and size of the container and the method of ejection used, the containers can settle on the initial conveyor, net or shaker both right way up and upside down, as well as at any point along and across the conveyor within a broad range. Further, where the containers are not round, they may be orientated in a variety of ways relative to the direction of travel along the conveyor or chute. The speed of the production line would be increased if the containers could be sorted into a more uniform orientation prior to any stacking operation.

In a current state of the art, guides are positioned above the conveyor means and as close to the die as practicable to guide the containers into constant starting positions with a pre-determined orientation. Sometimes a combination of guides is used. After the use of a set of guides appropriate to the size, shape and orientation of container being ejected, the majority of the containers are positioned at desired distances across the conveyor.

The homogenous order and position of the containers then allows for further semi-automatic and automatic stacking means. For example, in one state of the art, a curved metal chute which tilts the container from the horizontal to the vertical by allowing it to fall an amount slightly longer than the container's own length, is positioned after the guiding conveyor and forces the container onto one of its side or ends after the initial conveyor system. The container falling over the curved metal chute falls onto a second conveyor whereupon rests a nested stack of containers all on their sides or ends as desired. A small puff of air is then typically applied to the last container to fall to assist it to nest side-ways in the formed stack. The stack is then conveyed by the second conveyor at a rate appropriate to allow additional containers to fall and nest. This is typically called a “Waterfall” Stacker. The actual stacking process is semi-automatic; however an operator is still required to watch for upside down or incorrectly positioned containers and to adjust the stack periodically. Further, the stack could be of arbitrary size, and a human operator is typically used in order to break up the stacks into the desired number of containers for packaging.

Achieving the desired number of containers in a stack can be the result of human counting, or alternatively could be counted by height or weight. Alternatively, a mechanical counting device is sometimes used which places a coloured piece of paper, plastic or metal after a certain number of containers in the stack.

In order to allow more containers to be stacked in the fastest time possible, a multi-channel tool or die with subsequent multi-channel conveyor is often used. This allows for two or more parallel stacks to be formed at the same time. In some cases, a further conveyor, positioned immediately after the first conveyor and known as a separation conveyor, is often used to increase the distance between the containers prior to stacking. This allows for improved feeding of the containers onto the stack, as well as providing separation between the containers.

The above forms of the art still require a human operator to perform a major role in the stacking process. This has inherent limitations in productivity and speed of the process. In high volume manufacturing processes, automatic stacking is preferred as it increases manufacturing speed and lowers labour content.

In the current form of automatic stacking means, a single or multi channel initial conveyor, known as the receiving conveyor, receives the containers from the stamping press or similar and guides them into channels. A separation conveyor is then often situated after the receiving conveyor to control the speed and increase the distance between the containers prior to entering the automatic stacking means.

At the end of the separation conveyor, each container is dropped into a stacker head. This consists of a pair of vertical guides parallel to the container and conveyor direction at a slightly larger width than the containers, together with a stop plate perpendicular to the guides at a certain distance from the edge of the conveyor to ensure the container does not travel too far past the end of the conveyor. Once the dish is in the stacker head, after hitting the stop plate, it drops vertically onto the stacking assembly. As the process is repeated, a stack is formed within the stacking assembly. The dropping of the container may be assisted by a puff of compressed air or other mechanical means.

In a current state of the art, the stacking assembly typically consists of an elevator mechanism and a number of auxiliary mechanisms. The elevator consists of a horizontal surface to catch the bottom container in the stack. As more dishes are dropped onto the stack, the elevator moves downwards a certain distance, often in jerks, such that the top of the stack stays approximately constant in height. The constant height provides a relatively constant environment for each dish to enter the stacking mechanism and drop on top of the stack already formed. Typically, there are also adjustable vertical guides on either side of the elevator mechanism in order to prevent the stack from toppling over. These guides are adjustable and the combination of these and the elevator mechanism allows a large variety of sizes of container to be accepted. As dishes fall onto the elevator, it continues to descend until the desired number or height of containers is achieved. At this point an auxiliary catching mechanism is typically used to catch the containers dropping from the conveyor while the elevator moves to the bottom of its range to clear the previous stack. Once the auxiliary mechanism is engaged, the elevator descends to an unloading position.

Typically, the auxiliary mechanism consists of two inwards facing L-shaped sections of metal pivoted at the top, which can be moved into the desired place at the desired time by mechanical, electrical, or other means, such as pressurised fluid or compressed air. Each L-shaped section is attached in a suitable place such that when required, each section can move into position underneath the end of the conveyor to provide a temporary catching means for the dropping containers. Once the previous stack has been removed from the elevator, the elevator moves back into the original position and the auxiliary mechanism moves back into its original position, causing the temporary container stack to drop onto the elevator. Typically, the temporary catching means can only hold a small number of containers in the stack depending on the size of the container; therefore there is a upper limit to the speed in which the initial conveyors can transfer the containers to the stacking means. At the same time, there is also an upper limit as to the speed at which the stacks can be removed from the elevator.

Typically, the removal of the stacks from the elevator is provided by a piston pushing the stack from one side onto a further exit conveyor which is situated at approximately the same height as the horizontal surface on the elevator when it is in the unloading position at the bottom of its travel. This exit conveyor then transports the stack along to be packed and shipped. Alternatively, instead of a piston being used, the elevator is able to pass through the exit conveyor and leave the stack on the conveyor. Once the conveyor has transported the stack away, the elevator can pass back into its original loading position at the top of its travel.

The prior art has limitations in speed because clearing of the elevator and its return to the loading position takes time. Often this means the press and conveyor systems cannot work at their optimum speed and efficiency. The want for faster production also forces the use of high power, high speed and hence relatively high cost electric motors and control systems. In addition, the cost of the elevator mechanism and associated sensors, electrical and electronic controls is high. Other problems in increasing the speed include the fact that if the piston pushing the stack onto the exit conveyor is too fast or powerful, the stack will also tip over. Further, the continual variability in the position of the elevator may cause uneven stacking and jams. High power components and high speeds of elevator and ejection mechanisms can also be a hazard to operators attempting to clear jams.

The process is not entirely reliable due to the above varying factors and it therefore requires a human operator to be present in order to oversee the timing and working of the process. It is difficult to increase productivity or efficiency in such manufacturing operations described above. Similar problems to those described above arise in relation to many kinds of containers, including those made from plastic, aluminium, paper or other materials.

It is an object of the present invention to provide a stacking assembly that removes at least some of the limitations inherent in the prior art and can thus preferably enable an increase in productivity, and in the speed of the manufacturing process.

### SUMMARY OF THE INVENTION

Accordingly, in a first aspect of the present invention there is provided an apparatus for the stacking of containers, including a plurality of substantially horizontal pairs of gates positioned in a substantially vertical series wherein operatively each said gate pair can be selectively closed or opened to allow said containers to either rest at each gate pair or pass through, so as to deliver a stack of containers below said gate pairs.

Preferably, each gate can be closed or opened by pivoting. Such pivoting on a suitably placed axle means that as the gates open they progressively tilt inwards towards the centre of the stack until they become vertical thereby releasing said stack. The process of tilting of the gates has the advantage of tending to centre the stack and release it evenly.

Preferably, there is at least one sensor positioned relative to each pair of gates in said apparatus to determine the number of containers stacked at each gate pair when closed.

Preferably, vertical guides are provided associated with the series of gates, and more preferably the guides are adjustable to allow for different shaped and sized containers.

In a second aspect of the present invention, there is provided a method for the stacking of containers delivered from a conveyor, said method including:

a) providing an apparatus having a plurality of substantially horizontal pairs of gates positioned in a substantially vertical series;

b) closing the uppermost gate pair to allow a first container to rest upon said uppermost gate pair;

c) selectively allowing a predetermined number of additional containers to stack upon said first container to form a stack of containers;

d) momentarily opening said uppermost gate pair to allow the said stack of containers to fall therethrough;

e) selectively closing a subsequent lower gate pair to receive said stack of containers thereupon;

f) momentarily opening said subsequent lower gate pair to allow said stack of containers to fall therethrough; and

g) repeating steps e) and f) for each subsequent gate pair in said substantially vertical series until said stack of containers is delivered below the lowermost gate pair.

Ideally, steps b) to g) are repeated to deliver one or more further stacks of containers onto the first stack of containers to form a larger stack of containers below said lowermost gate pair.

Preferably, the topmost gates are normally in a closed position, and opened only as required to move the containers to the next in the series of gates. Subsequent lower gates are preferably normally in the open position and are only closed to momentarily catch each small stack of containers so as to control their descent. Such lower gates only close when the stack that is building up and resting on the bottom pair of gates or below, does not reach above said lower gates as considered as individual pairs. If the lowest pair of gates is required to support, the stack building at the bottom of the mechanism, then said bottom pair of gates, is preferably normally closed. If however, the building stack normally rests on a conveyor or other surface below the lowermost pair of gates, then the lowermost pair of gates shall preferably be normally open.

The present invention allows a stack of containers to be controllably formed and transported from the stacking apparatus by being successively caught by, and then being allowed to fall through, each gate. The removal of the stack from the apparatus is achieved by allowing the stack to fall downwards through the final gate, conveniently onto a conveyer although other methods could be used.

The present invention overcomes the limitations in the prior art by not requiring the stacking process to be halted or altered or slowed down at any time during operation in order to allow the stack to be removed from the stacking apparatus, as is required in the case of an elevator, where part of the stacking apparatus must return to its starting point during the process. There is no need for an auxiliary mechanism during the stacking operation or during the removal process, as the stacking process can be managed according to the present invention to have sufficient capacity and speed to cope with the production volume in a continuous way, even at substantially higher speeds than the current state of the art. It can therefore increase the speed and productivity of the production and the stacking of containers. Further, there is no need for high powered motors and elevators and their associated sensors and the cost of the mechanism is substantially reduced.

The present invention may allow either a number of small stacks to be formed, or to eventually combine the small stacks into a larger stack. This method of formation of the stacks reduces the possibility of containers not nesting correctly.

The present invention has a speed of performance that is essentially independent of the height of the stack produced up to the limit of the mechanism whereas elevator stackers become progressively slower as the height of the final stack diminishes. The slowing down is determined by the ratio of the time to recycle the elevator to the start position at the end of a cycle, and the time to assemble a stack. In the present invention, the recycle time for the elevator does not apply. This means that the present invention has even more advantages when small stacks are desired.

### BRIEF DESCRIPTION OF THE DRAWINGS

Further features and aspects of the invention will become apparent from the following description of preferred embodiments given in relation to the accompanying drawings, in which:

FIG. 1 is a perspective view of the preferred embodiment of the apparatus according to the present invention;

FIG. 2 is a side view of an embodiment of the use of the apparatus according to the present invention;

FIG. 3 is a top view of the embodiment of FIG. 2;

FIG. 4 is an end view of the embodiment of FIG. 2;

FIG. 5 is a side view of another embodiment of the use of the apparatus according to the present invention;

FIG. 6 is a top view of the embodiment of FIG. 5.

### DESCRIPTION OF PREFERRED EMBODIMENT

In order that the invention might be more fully understood, embodiments of the invention will be described with reference to the accompanying drawings. Further optional and preferred features and advantages of the apparatus and method of the present invention will become apparent from the following description of these preferred embodiments. However, the embodiments described herein below should not be considered as limiting the scope of the invention or any of the preceding statements.

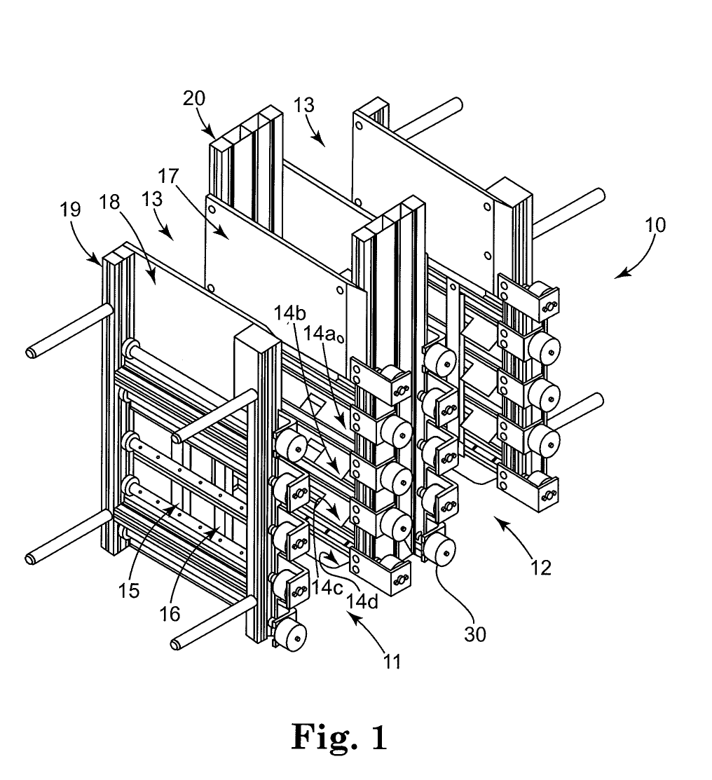

FIG. 1 shows a preferred embodiment of the stacker 10 including two channels 11, 12. A multi-channel stacker allows for more than one stack to be formed at the same time and there is no significant limit to the number of parallel channels which can be accommodated. This embodiment will describe the features and technicalities referring only to one channel, however all channels are formed and are used in identical ways.

The stacker 10 includes a number of frames 19, 20 to which are attached pairs of gates 14a-14d. The gates 14a-14d may be constructed of any suitable material, although metal is presently preferred. Preferably, each pair of gates consists of two relatively flat rectangular plates that are horizontally positioned at equal heights. It will be understood that the gates may be constructed in other forms, so long as their geometry permits them to function as required. As such, the two plates in each gate are situated opposite each other and enter the path of the descending containers to provide a catching mechanism when the gate is closed. In FIG. 1 there is shown four pairs of said gates.

It will be understood that while the gates shown in FIG. 1 are made of relatively flat rectangular plates that are bent at right angles, mounted on a shaft that rotates so that the gates act as either open or closed between the vertical guides 17 and 18.

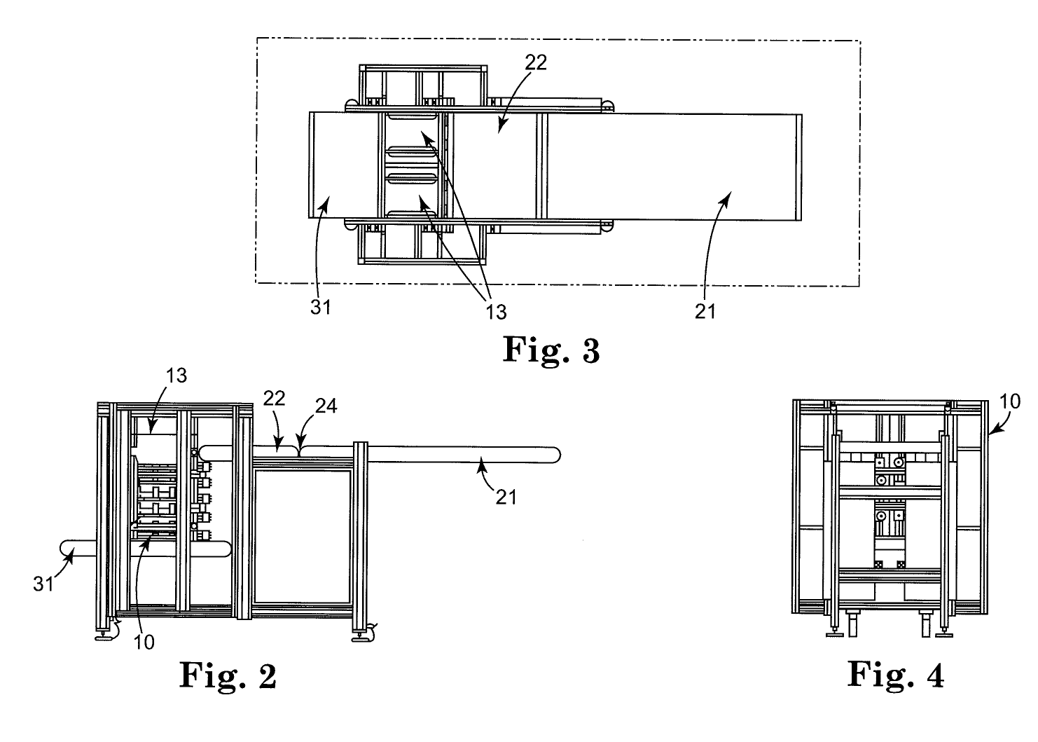

FIG. 2 shows an embodiment of the stacker 10 in use as part of the manufacturing process for the containers. This shows the side view of the stacker and conveyors. FIG. 4 is the end view of the stacker as seen from the exit conveyor end.

The production line begins with the stamping press, which is not shown in the figures forming the shape of the container. The present invention can be used for stacking containers made out of a variety of materials including, but not limited to, aluminium foil, plastics of different formulations, paper or paper composites. The stamping press may be any suitable apparatus for the formation of the containers, the exact features and types of such press depending upon the material from which the container is made. The press itself does not form part of the present invention, and so will not be described in detail. It will be understood that the press may be replaced depending upon the relevant manufacturing process, for example by an injection moulding machine for plastic containers.

The containers are ejected from the press onto an input conveyor 21. The input conveyor 21 ideally incorporates guides situated above the conveyor in order to align and orient the containers into a constant position across the width of the input conveyor 21. Part of these guides may reside within the stamping press as near the die as possible. If a multi-channel stacker is used, there should ideally be multiple sets of guides in order to produce multiple alignments of containers ready for input into each stacker head 13.

In the embodiment shown in FIG. 2, there is provided a second conveyor 22, called the separation conveyor. The separation conveyor 22 is run at a faster speed than the input conveyor 21. The increased speed is used to increase the distance between adjacent containers, thereby separating the containers that are touching or bunched up prior to input into the stacker head 13 and thereby the stacking mechanism 10.

At the end of the separation conveyor 22, the containers are delivered into the stacking head 13. The stacking head 13 consists of a type of box open at the top and bottom and at the side from which the dishes enter. The sides and end of the box 17, 18 may be made from any material, such as aluminium, steel or plastic. The sides of the box 17, 18 are attached to the respective apparatus frames 19, 20, by any suitable means. Typically, the far end of the box is used as the stop plate, to ensure the containers fall within the length of the stacking head 13 and therefore do not pass over the stacker 10. To assist the containers to fall into the stacking head 13, there may be a puff of compressed air applied from above the stacker 10 to drive the container firmly and predictably downwards to form a stack of containers.

Preferably, the width between the sides of the box 17, 18 is adjustable so as to allow the stacker 10 to be used for different sized containers. Having the width adjustable results in a more controlled stacking process, where the width can be set to just wider than the diameter or width of the containers. This adjustability could be achieved by fixing the stacker 10 to runners where either mechanically or electrically one or both sides of the frames 19, 20 can be moved. Any other means for adjusting the distance between the two frames 19, 20, and respectively the two sides of the stacking head 17, 18 may be used. Alternatively, only the width of the stacking head 13 may be adjustable rather than the whole apparatus 10. The Stop Plate is also adjustable to allow for different sizes of container.

When a container falls into the stacking head 13, it rests preferably on the upper most set of gates 14a. In order for this to occur, the upper most set of gates 14a will need to be set such that the distance between the two gates when closed is smaller than the width of the container to be stacked. This may be achieved in a number of ways. In the embodiment shown in FIG. 1, the gates are pivotally mounted such that the angle between the gates and the vertical frame 20 can be increased or decreased. In this example the angle can be varied approximately 45 degrees. When positioned at zero degrees, the ends of the gates which are bent such that they are approximately tangential to a circle centred on the actuating shaft, are positioned such that the gate is closed. When rotated approximately 45 degrees the ends of the gate are withdrawn from within the vertical frame such that the gate is open, thereby allowing the container to fall through the gate. Each side of the pair of gates should preferably be set at the same angle to provide for an approximately horizontal surface on which the stack can rest. The dimensions of each gate and the associated rotation of the actuating shaft to allow gates to be open and closed can be varied within broad limits to achieve the same result. Gates may be assisted by the use of springs or counterweights if required to hold either the open or closed position when the actuator is not powered.

It may be understood that other gate means could be used to produce the same effect. An example of such is if the gates are opened and closed by moving each gate inwards and outwards horizontally rather than pivotally. The present invention is not limiting in this respect. In this respect, it is the required function which is critical, not the specific mechanical construction of the gates. It is however noted that some forms of construction are preferred. Gates which open by rotating the gate downwards have the advantage of tending to centre the container or stack of containers on the sloping surface produced as the gate opens. This is an advantage as the vertical guides that form the sides of the box 17 are typically set wider than the container to prevent jamming. As such, the containers will generally not stack perfectly on the centres of the gates.

The upper most gate 14a will stay in the at least partially closed position until the stack resting upon it includes the required number of containers. Typically, this will be between 5 and 10 containers in order to allow for greatest efficiency and workability of the stacker 10. When the stack includes the required number of containers, the upper most gate 14a will move into its open position, thereby allowing the stack of containers to drop. Preferably, the stack will fall through to the second gate 14b, which would be in its at least partially closed position. The upper most gate 14a would then return to its at least partially closed position in order to catch the next container and so build a new stack of containers.

Sequentially, after arresting or partially arresting the falling stack, the second gate 14b would then move to its open position to allow the stack to fall through to the next gate 14c, and so on until the stack reaches the final gate 14d. Determining when a gate will move to its open or closed position may be pre-determined, for example after a desired time interval, or dependent on the number of containers resting on the gate, or determined by any other dependent or independent factors. The present invention is not limiting in this respect. Preferably, the catching of the stack in the second and subsequent gates is momentary, while allowing sufficient time to stabilise the stack. While the number of gates is not essential, for favourable workability and efficiency.

In the embodiment shown in FIG. 1, the pivoting process of the gates uses a rotary electrical actuator 30. This is not essential however and many other electromechanical or mechanical means could be used. If a suitable brushless rotary actuator is used, typically speeds of approximately 10 ms or less are experienced for each opening and closing process. In many applications lower powered actuators with slower speeds can be used.

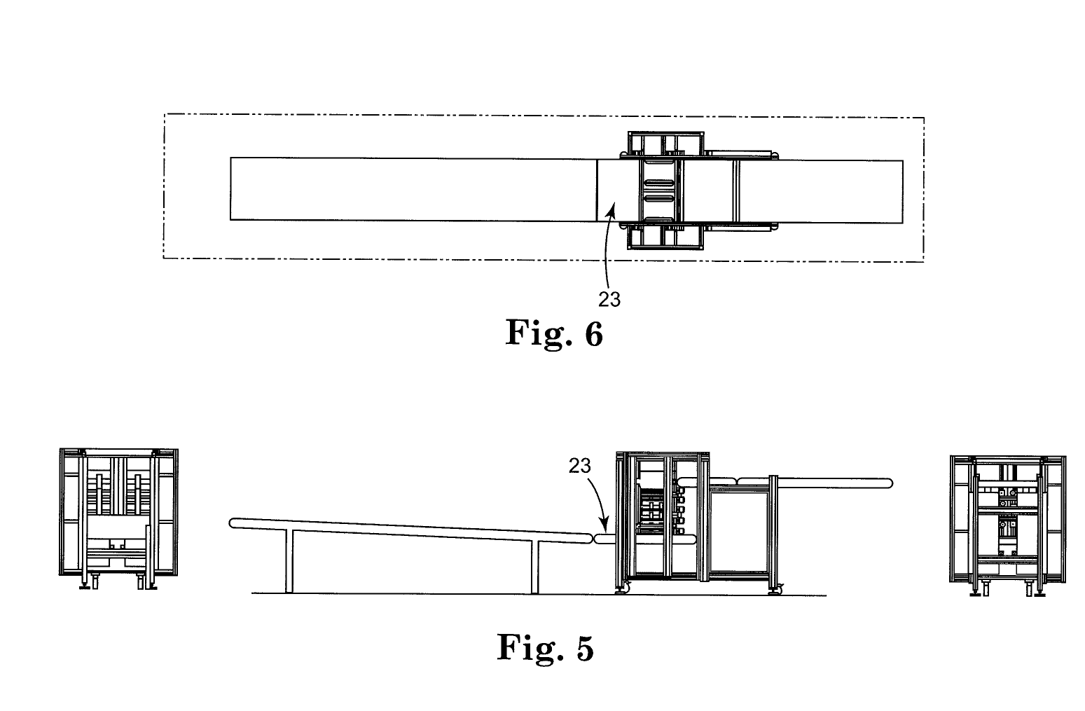

When a stack rests on the lower most gate 14d, that stack can be removed from the stacker 10 simply by opening the gate 14d. Preferably, there exists an exit conveyor 23 underneath the stacker 10 as shown in FIGS. 5 and 6. Thus, when the stack falls from the lower gate 14d, it rests on the exit conveyor 23 and is thus automatically transported away to be packed and shipped.

If a larger stack should be desired, as is typically the case, the final gate 14d can remain in the closed position for a longer period of time, thereby adding the subsequently dropping stacks onto the existing one. Once the desired number of containers in the stack is provided, the lower most gate 14d can open and the stack will be dropped onto the exit conveyor 23. The desired height of the final stack should preferably be below the top catching mechanism and below the stop plate which it must clear to exit successfully.

As a stack builds on the bottom pair of gates, preferably the height is sensed at certain points, or continuously, and the intermediate gates between the top and the bottom gates are kept open as required to accommodate the building stack. Alternatively, smaller stacks can be built momentarily on each set of gates and dropped onto lower stacks as and when desired.

Alternatively, there exists a platform 31 underneath the stacker 10 as shown in FIGS. 2 and 3. Subsequent stacks may be dropped from the stacker 10 onto the platform 31 until the desired height or number of containers in the stack is obtained. The stack may then be removed by any means, for example, a piston may push the stack onto an exit conveyor adjacent to the platform.

Using the stacker 10 as described in the present invention does not require a separate removal process or function such as an elevator as is required in the prior art. This increases the overall speed of the stacking process. Further, the process of repeated dropping of the stack a small distance and subsequently catching the stack produces a more controlled process where there is less chance of events occurring such as the unbalancing and tipping over of the stack, and therefore a lower need for human interaction. In practice, this means less human resources are required, a decrease in costs, and an increase in speed and productivity. In addition, smaller stacks may be produced. Elevator stackers are suited to large stacks due to the time required for the elevator to cycle to the bottom and return to the top to repeat the entire process. In the invention, such limitations are not present and small stacks may be produced for subsequent processes such as packaging small stacks for retail sale rather than larger stacks for wholesale sale.

Preferably, there includes a number of sensors along the production line, and within the stacker 10. In the embodiment shown in FIG. 2, there is a sensor 24 between the input and separation conveyors in order to count containers coming on to the separation conveyor 22 and hence into the stacker assembly 10. Since the speed of the separation conveyor 22 is known, the future time of arrival of the each container into the stacker head 13 can be calculated and used as a trigger to drop the stack being held by the top pair of gates 14a such that the stack will drop and the gates 14a closed again in time for the arrival of that container. If there is insufficient time for such a cycle as determined by sensor 24 the sensor will communicate with a mechanism such as an electric solenoid or air piston, to momentarily prevent additional containers entering the separation conveyor 22 near sensor 24, forcing them to temporarily bank up on conveyor 21.

Preferably there is also a further sensor as the containers are entering the stacking head 13. Typically this further sensor would be an electric eye or a light beam, although any suitable sensor may be used. This is a back-up sensor to 24 and may have additional functions. This further sensor (or sensor 24 by calculation) can initiate a puff of compressed air that is preferably applied to the container as it enters into the stacking head 13 in order to drive the dish downwards to form a stack. This sensor can also be used to check or determine the number of dishes that have entered the stacking apparatus 10, thus determining the number of dishes in any one or part stack. This can also be used to automatically determine when the respective gate should open or close. It can also be used to automatically count the number of containers in a stack.

Alternatively or in addition, the vertical set of guides which are shown as 17 and 18 in FIG. 1 in the top of the stacker 10 and are continued as 15,16 and their counterparts (not shown) on the other side of the stacker below 17 and 18, between which the containers fall, is fitted with sensors to sense the height of the stack formed. This automatically enables each gate pair to open and close depending upon the number of containers resting upon it and upon gate pairs below it.

The time of opening each subsequent gate, the number of containers accumulated at each level before allowing them to drop to the next level, the time they are accumulated, the number of containers required to be accumulated at the lowermost gate, and the like are variables which will depend upon the production process and the requirements for further handling. It would be expected that these will vary for different container types and sizes. Moreover, they may be varied as production progresses, for example to retain more containers at higher levels if the lower levels are becoming more full to accommodate effective removal of completed stacks.

It will be appreciated that appropriate control software will need to be provided, to co-ordinate the movement of gates, counting of containers, and the like. This will need to interact with the operation of the production system, so that it will be specific to the production line in which it is installed, to some extent. Control of such devices as are used in this implementation is well understood in the art and appropriate software can be designed, in accordance with the general principles discussed.

The process is much faster than the traditional elevator as there is no elevator required to move to the unload position and subsequently return to the top position. Also, since the small stacks are always formed in the same place on top of the catching mechanism, the stacking is more reliable.

1. An apparatus for the stacking of containers including:
a plurality of substantially horizontal pairs of gates positioned in a substantially vertical series wherein operatively each said gate pair can be selectively closed or opened to allow said containers to either rest at each gate pair or pass through, so as to deliver a stack of containers below said gate pairs.

2. The apparatus according to claim 1 wherein said gate can be closed or opened by pivoting.

3. The apparatus according to claim 1, wherein at least one sensor is positioned relative to each pair of gates in said apparatus to determine the number of containers stacked at each gate pair when closed.

4. The apparatus according to claim 1, wherein the horizontal distance between each said pair of gates is adjustable.

5. The apparatus according to claim 1, further comprising vertical guides for guiding containers as they pass through the apparatus.

6. A method for stacking of containers delivered from a conveyor, said method comprising:
a) providing an apparatus having a plurality of substantially horizontal pairs of gates positioned in a substantially vertical series;
b) closing the uppermost gate pair to allow a first container to rest upon said uppermost gate pair;
c) selectively allowing a predetermined number of additional containers to stack upon said first container to form a stack of containers;
d) momentarily opening said uppermost gate pair to allow said stack of containers to fall therethrough;
e) selectively closing a subsequent lower gate pair to receive said stack of containers thereupon;
f) opening said subsequent lower gate pair to allow said stack of containers to fall therethrough; and
g) repeating steps e) and f) for each subsequent gate pair in said substantially vertical series until said stack of containers is delivered below the lowermost gate pair.

7. The method according to claim 6, wherein steps b) to g) are repeated in order to deliver one or more further stacks of containers, and stacking said one or more further stacks of containers onto the first stack of containers to form a larger stack of containers below said lowermost gate pair.

8. The method of claim 6 further comprising, operating a sensor positioned relative to each pair of gates to determine the number of containers stacked at each gate pair when closed.

9. The method of claim 6 further comprising adjusting the horizontal distance between at least one pair of gates to just wider than the diameter or width of containers to be stacked.

10. The method of claim 6, further comprising operating at least one vertical guide for guiding containers as they pass through the apparatus.

11. The apparatus according claim 2, wherein at least one sensor is positioned relative to each pair of gates in said apparatus to determine the number of containers stacked at each gate pair when closed.

12. The apparatus according to claim 2, wherein the horizontal distance between each said pair of gates is adjustable.

13. The apparatus according to claim 3, wherein the horizontal distance between each said pair of gates is adjustable.

14. The apparatus according to claim 2, further comprising vertical guides for guiding containers as they pass through the apparatus.

15. The apparatus according to claim 3, further comprising vertical guides for guiding containers as they pass through the apparatus.

16. The apparatus according to claim 4, further comprising vertical guides for guiding containers as they pass through the apparatus.
